(19) United States
(12) Patent Application Publication
(10) Pub. No.: US 2023/0145177 A1
(43) Pub. Date: May 11, 2023

(54) FEDERATED LEARNING METHOD AND FEDERATED LEARNING SYSTEM BASED ON MEDIATION PROCESS

(71) Applicant: INSTITUTE FOR INFORMATION INDUSTRY, TAIPEI CITY (TW)

(72) Inventors: PING-FENG WANG, TAIPEI CITY (TW); CHIUN-SHENG HSU, TAIPEI CITY (TW); JERRY CHI-YUAN CHOU, HSINCHU CITY (TW)

(21) Appl. No.: 17/535,576

(22) Filed: Nov. 25, 2021

(30) Foreign Application Priority Data
Nov. 5, 2021 (TW) 110141246

(51) Int. Cl. G06N 20/00; H04L 41/0668; H04L 41/16; H04L 67/1095

(52) U.S. Cl. CPC G06N 20/00; H04L 41/0668; H04L 41/16; H04L 67/1095

(57) ABSTRACT

A federated learning method and a federated learning system based on mediation process are provided. The federated learning method includes: dividing a plurality of client devices into a plurality of mediator groups, and generate a plurality of mediator modules; configuring a server device to broadcast initial model weight data to the plurality of mediator modules; configuring the plurality of mediator modules to execute a sequential training process for the plurality of mediator groups to train a target model and generate trained model weight data; configuring the server device to execute a weighted federated averaging algorithm to generate global model weight data; and configuring the server device to set the target model with the global model weight data to generate a global target model.

### CROSS-REFERENCE TO RELATED PATENT APPLICATION

This application claims the benefit of priority to Taiwan Patent Application No. 110141246, filed on Nov. 5, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a federated learning method and a federated learning system, and more particularly to a federated learning method and a federated learning system based on a mediation process.

### BACKGROUND OF THE DISCLOSURE

In the existing federated learning method, a model can be trained on a local device without transferring local data from a client end, and a shared model can then be further established and updated. This method not only has high confidentiality, but also saves costs of dense transmissions of large amounts of data. However, the local data collected by different client ends cause a data deviation due to factors such as environment and location, and this data deviation reduces an accuracy of the trained model.

In addition, the existing federated learning method connects a server to a plurality of client devices for learning. However, selected client devices often experience interruptions in network communication, thereby causing a collecting process in the federated learning method being executed by the server to cease.

### SUMMARY OF THE DISCLOSURE

In response to the above-referenced technical inadequacies, the present disclosure provides a federated learning method and federated learning system based on a mediation process.

In one aspect, the present disclosure provides a federated learning method based on a mediation process. The federated learning method includes: configuring a server device to divide a plurality of client devices into a plurality of mediator groups based on a plurality of records of data distribution information of the plurality of client devices, and generate a plurality of mediator modules that are configured to manage the plurality of mediator groups, respectively; configuring the server device to broadcast initial model weight data to the plurality of mediator modules; configuring the plurality of mediator modules to execute a sequential training process for the plurality of mediator groups, respectively, in which the sequential training process includes: determining a training sequence for the corresponding client devices; transmitting the initial model weight data to the corresponding client devices, and configuring the corresponding client devices to use a plurality of records of local data as a plurality of records of training data, and sequentially train a target model according to the initial model weight data and the training sequence to generate trained model weight data; and transmitting the trained model weight data back to the server device. The federated learning method further includes: configuring the server device to obtain multiple records of the trained model weight data of the plurality of mediator groups, and calculate a plurality of weights respectively corresponding to the plurality of mediator groups according to the multiple records of the trained model weight data; configuring the server device to execute a weighted federated averaging algorithm on the multiple records of the trained model weight data according to the plurality of weights to generate global model weight data; and configuring the server device to set the target model with the global model weight data to generate a global target model.

In another aspect, the present disclosure provides a federated learning system based on a mediation process. The federated learning system includes a plurality of client devices, a server device, and a plurality of mediator modules. The server device is communicatively connected to the plurality of client devices, and is configured to divide the plurality of client devices into a plurality of mediator groups based on a plurality of records of data distribution information of the plurality of client devices. The plurality of mediator modules are generated by the server device and configured to manage the plurality of mediator groups, respectively. The server device is configured to broadcast initial model weight data to the plurality of mediator modules. The plurality of mediator modules are configured to execute a sequential training process for the plurality of mediator groups, respectively, and the sequential training process includes: determining a training sequence for the corresponding client devices; transmitting the initial model weight data to the corresponding client devices, and configuring the corresponding client devices to use a plurality of records of local data as a plurality of records of training data, and sequentially train a target model according to the initial model weight data and the training sequence to generate trained model weight data; and transmitting the trained model weight data back to the server device. The server device is configured to obtain multiple records of the trained model weight data of the plurality of mediator groups, and calculate a plurality of weights respectively corresponding to the plurality of mediator groups according to the multiple records of the trained model weight data. The server device is configured to execute a weighted federated averaging algorithm on the multiple records of the trained model weight data according to the plurality of weights to generate global model weight data. The server device is configured to set the target model with the global model weight data to generate a global target model.

Therefore, the federated learning method and federated learning system based on the mediation process provided by the present disclosure add mediators in federated learning to coordinate training tasks in the mediator group, thereby assisting model weights to be transferred between the client ends and server to overcome uneven distribution of data in the federated learning, while having high privacy and low cost characteristics.

In addition, the federated learning method and federated learning system based on the mediation process provided by the present disclosure provide a fault-tolerant mechanism under a mediator architecture of the federated learning, such that the training efficiency and stability of the model can be maintained even if the client device is disconnected during the training process.

Furthermore, the federated learning method and federated learning system based on the mediation process provided by the present disclosure can operate in parallel through a plurality of mediator modules, and each uses a sequential training method to allow the client devices to update the global model in a specific sequence, therefore, not only can biased weights be avoided, but also communication costs can be reduced, thereby speeding up an overall training speed of the federated learning.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a federated learning system according to one embodiment of the present disclosure;

FIG. 2 is a functional block diagram showing a server device and a client device according to one embodiment of the present disclosure;

FIG. 3 is a flowchart of a federated learning method according to one embodiment of the present disclosure;

FIG. 4 is a flowchart of a sequential training process according to one embodiment of the present disclosure; and

FIG. 5 is a flowchart of a fault-tolerant process according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

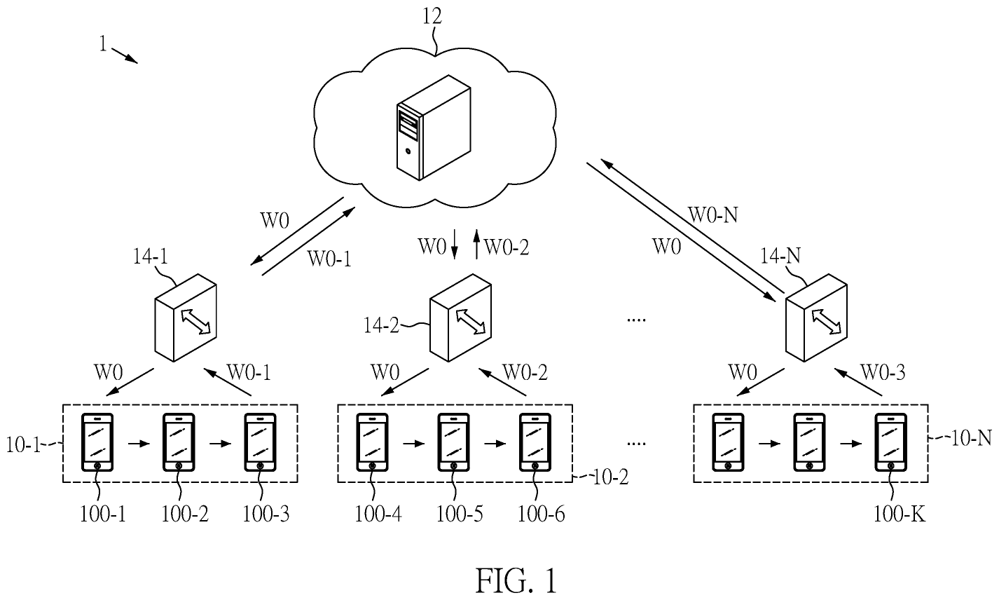

FIG. 1 is a schematic diagram of a federated learning system according to one embodiment of the present disclosure. Reference is made to FIG. 1, one embodiment of the present disclosure provides a federated learning system 1 based on a mediation process, and the federated learning system 1 includes client devices 100-1, 100-2, . . . , 100-K, a server device 12, and mediator modules 14-1, 14-2, . . . , 14-N.

The server device 12 is communicatively connected to the client devices 100-1, 100-2, . . . , 100-K, and is configured to divide the client devices 100-1, 100-2, . . . , 100-K into mediator groups 10-1, 10-2, . . . , 10-N based on a plurality of records of data distribution information of the client devices 100-1, 100-2, . . . , 100-K. The mediator modules 14-1, 14-2, . . . , 14-N are generated by the server device 12 and are configured to manage the mediator groups 10-1, 10-2, . . . , 10-N, respectively. The number of the mediator modules 14-1, 14-2, . . . , 14-N is the same as the number of the mediator groups 10-1, 10-2, . . . , 10-N, but the present disclosure is not limited thereto.

In the federated learning system 1, a main task of the server device 12 is to initialize and assign the client devices 100-1, 100-2, . . . , 100-K to the different mediator groups 10-1, 10-2, . . . , 10-N according to data distribution. For example, the mediator group 10-1 includes the client devices 100-1, 100-2, 100-3, and the mediator group 10-2 includes the client devices 100-4, 100-5, 100-6. The server device 12 further creates the mediator modules 14-1, 14-2, . . . , 14-N for the mediator groups 10-1, 10-2, . . . , 10-N, and executes a weighted federated averaging algorithm for model weights trained by the mediator groups 10-1, 10-2, . . . , 10-N, and finally generates a model that integrates all training results.

On the other hand, the client devices 100-1, 100-2, . . . , 100-K are responsible for processing data requests on a data plane, performing training, and transferring the weights of the trained models. In addition, in the federated learning system 1, in order to coordinate the training tasks among the client devices 100-1, 100-2, . . . , 100-K, the present disclosure includes the mediator modules 14-1, 14-2, . . . , 14-N, which are responsible for a control plane to provide software programs for configuring and closing the data plane, and also determine which client device should be used for training.

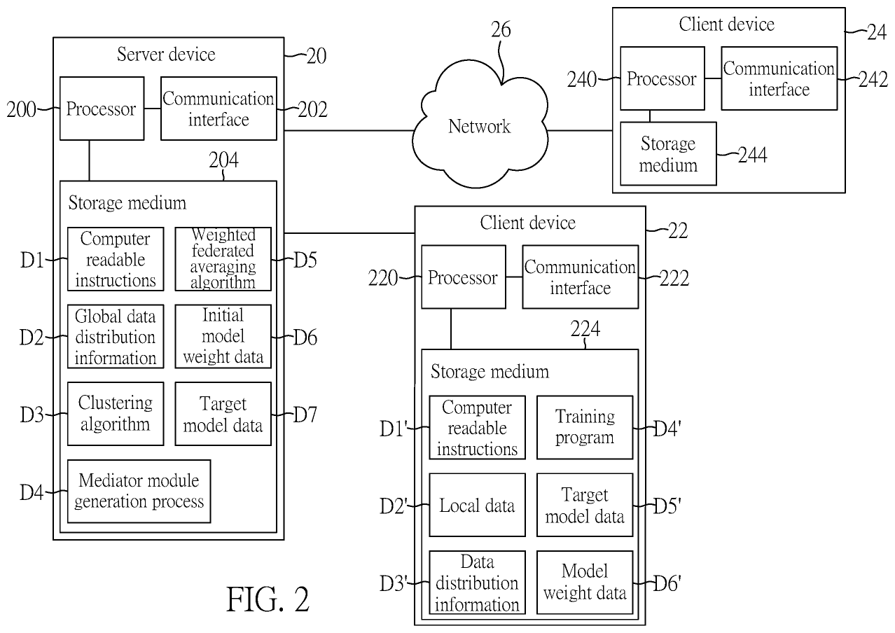

Reference is made to FIG. 2, which is a functional block diagram showing a server device and a client device according to one embodiment of the present disclosure. As shown in FIG. 2, in one embodiment, the server device 20 can be communicatively connected to the client devices 22 and 24. For example, the server device 20 can be directly connected to the client device 22, and can be connected to the client device 24 through network 14, but the above is only an example, and the present disclosure is not limited thereto.

The server device 20 includes a processor 200, a communication interface 202 and a storage medium 204. The processor 200 is coupled to the communication interface 202 and the storage medium 204. The storage medium 204 can be, for example, but not limited to, a hard disk, a solid state drive or other storage devices that can be used to store data, and is configured to store at least a plurality of computer readable instructions D1, global data distribution information D2, a clustering algorithm D3, a mediator module generation program D4, a weighted federated averaging algorithm D5, initial model weight data D6, and target model data D7. The communication interface 202 is configured to access the network under control of the processor 200, and can communicate with the client devices 22, 24, for example.

The client device 22 can include a processor 220, a communication interface 222, and a storage medium 224. The processor 220 is coupled to the communication interface 222 and the storage medium 224. The storage medium 224 can be, for example, but not limited to, a hard disk, a solid state drive or other storage devices that can be used to store data, and is configured to store at least a plurality of computer readable commands Dr, local data D2′, data distribution information D3′, a training program D4′, target model data D5′, and model weight data D6′. The communication interface 222 is configured to perform network access under control of the processor 220, and can communicate with the client device 22, for example.

Similarly, the client device 24 can include a processor 240, a communication interface 242, and a storage medium 244. The processor 240 is coupled to the communication interface 242 and the storage medium 244, and the storage medium 244 and the communication interface 242 are similar to the storage medium 224 and the communication interface 222, and thus the repeated descriptions are omitted. In some embodiments, the client devices 22 and 24 can be, for example, mobile devices, Internet of Things (IoT) devices, fog computing apparatus, and the like.

In addition, the mediator modules 14-1, 14-2, . . . , 14-N in FIG. 1 can be implemented in a form of hardware or software. In hardware implementations, the mediator modules 14-1, 14-2, . . . , 14-N can be implemented by an architecture similar to the server device 20, and can be communicatively connected between the server device 20 and the client devices 22, 24. In software implementations, the mediator modules 14-1, 14-2, . . . , 14-N can be stored in the storage medium 204 of the server device 20 in a form of computer readable instructions or application programs and can be executed by the processor 200, but the above is only an example, and the present disclosure is not limited thereto.

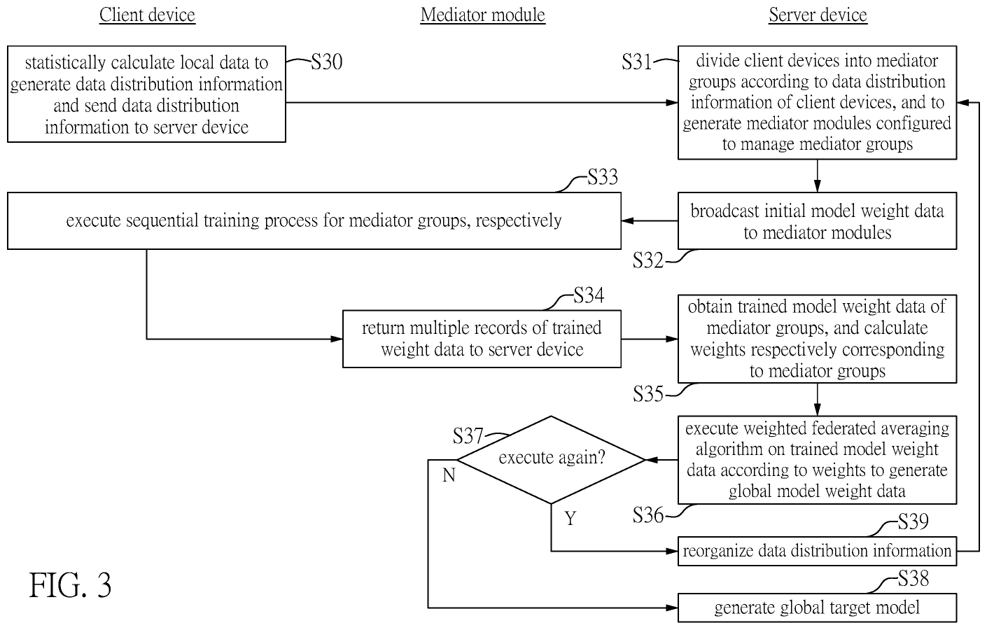

FIG. 3 is a flowchart of a federated learning method according to one embodiment of the present disclosure. Reference is made to FIG. 3, one embodiment of the present disclosure provides a federated learning method based on a mediator process, and the federated learning method is suitable for the aforementioned federated learning system and includes at least the following steps:

Step S30: configuring the client device to statistically calculate local data to generate data distribution information and send the data distribution information to the server device. In detail, this step is included in an initialization process. In the initialization process, the server device can communicate with multiple client devices that are predetermined to participate in the federated learning method, and a registration process is then executed. As shown in FIG. 2, the registration process can assign identifiers to the client devices 22 and 24, and collect data distribution information from the client devices 22 and 24. For example, the client device 22 can be configured to statistically calculate the local data D2′ to generate data distribution information D3′, and send the data distribution information D3′ to the server device 20 during the registration process. Multiple records of the data distribution information D3′ are finally collected by the server device 20 to generate the global data distribution information D2. The data distribution information D3′ can include, for example, an average value, a standard error, a median, a standard deviation, a sample variance, a kurtosis, a skewness, a range, a minimum, a maximum, and a sum obtained by statistically calculating the local data D2′.

Step S31: configuring the server device to divide the client devices into a plurality of mediator groups according to a plurality of records of data distribution information of the client devices, and to generate a plurality of mediator modules that are configured to manage the plurality of mediator groups, respectively. In this step, the processor 200 of the server device 20 can be configured to execute the clustering algorithm D3, based on the data distribution of the client devices 22, 24, for example, statistics of the global data distribution information D2 such as an average value, a standard error, a median, a standard deviation, a sample variance, a kurtosis, a skewness, a range, a minimum, a maximum, and a sum, so as to perform an average clustering. A clustering result can be as shown in FIG. 1, in which the client devices 100-1, 100-2, . . . , 100-K are divided into the mediator groups 10-1, 10-2, . . . , 10-N.

Next, the server device 20 can further execute the mediator module generation process D4 to set the mediator module. In the software implementations, the mediator module generation program D4 can be executed to determine where to execute the mediator modules. For example, in addition to executing the mediator modules on the server device, geographical characteristics or distance characteristics of the client devices can be further collected during the registration process, such that a shared server can be selected based on the corresponding mediator group under the premise that there is a shared server to execute the mediator modules. In the hardware implementations, a device similar to the server device can be set up according to the geographic characteristics or distance characteristics of the client devices in the mediator group, so as to manage the corresponding mediator group. The above are only examples, and the present disclosure is not limited thereto.

Step S32: configuring the server device to broadcast initial model weight data to the mediator modules. As shown in FIG. 2, in this step, a pre-selected target model can be inserted in the target model data D7, which can be broadcasted to all mediator modules together with the initial model weight data D6 used to set the target model. Reference can be also made to FIG. 1 that the server device 12 broadcasts an initial model weight W0 to all the mediator modules 14-1, 14-2, . . . , 14-N.

Step S33: configuring the mediator modules to execute a sequential training process for the mediator groups, respectively.

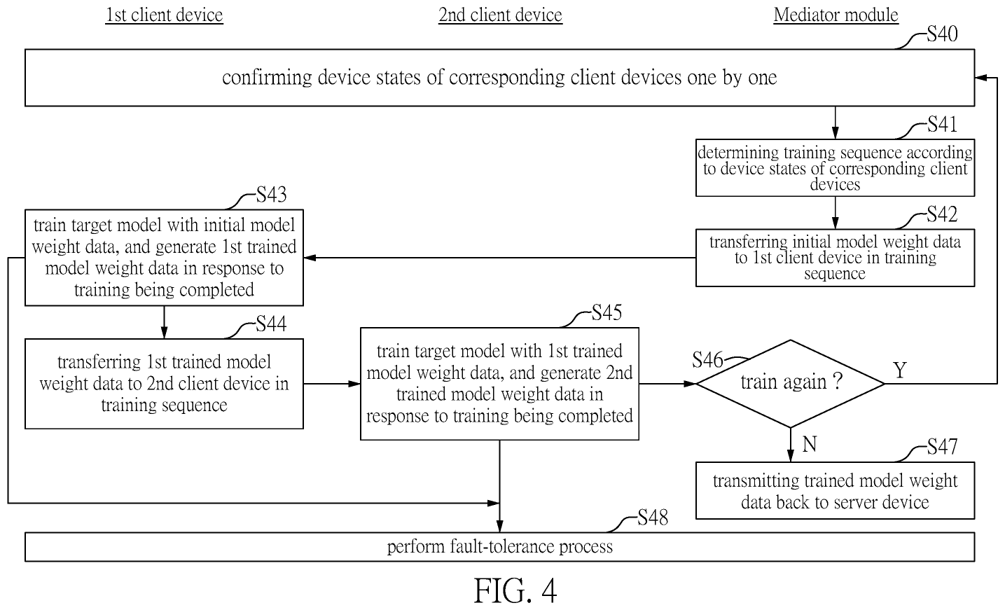

Reference is made to FIG. 4, which is a flowchart of a sequential training process according to one embodiment of the present disclosure.

As shown in FIG. 4, the sequential training process can include the following steps. Step S40: confirming the device states of the corresponding client devices one by one. Step S41: determining the training sequence according to the device states of the corresponding client devices. Then, the initial model weight data is transmitted to the corresponding client devices, for example, step S42 can be performed: transferring the initial model weight data to a first client device in the training sequence.

Furthermore, the corresponding client devices can be configured to use multiple records of local data as multiple records of training data, and sequentially train the target model according to the initial model weight data and the training sequence to generate trained model weight data. For example, the following steps S43 to S45 can be executed.

Step S43: configure the first client device to train the target model with the initial model weight data, and generate first trained model weight data in response to the training being completed. For example, as shown in FIG. 2, the first client device can be, for example, the client device 22, and the processor 220 can be configured to execute the training program D4′ to train the target model. For example, the target model can be configured with the initial model weight data, and the local data can be used as training data for training. The target model can be, for example, a convolutional neural network (CNN), which can include a convolution layer, a pooling layer, and a fully connected layer. Weight combination given to a convolution kernel is continuously updated along with the training process until a training completion condition (such as convergence or predetermined accuracy) is met, the weight combination is then transferred to the next client device in the training sequence.

Step S44: transferring the first trained model weight data to a second client device in the training sequence.

Step S45: configuring the second client device to train the target model with the first trained model weight data, and generate second trained model weight data in response to the training being completed. Similarly, after the target model is set with the first trained model weight data, local data of the second client device can be used as the training data for training until all the client devices in the training sequence complete the training, and trained model weight data is generated.

The sequential training process proceeds to step S46: determining, according to the trained model weight data, whether or not the sequential training process needs to be executed again. That is, whether or not the training process is performed again can be determined according to a training result. For example, the training process can be determined to be performed again according to the training result if it is desired to test whether or not an accuracy of the trained target model can be further improved.

In response to determining in step S46 that the sequential training process needs to be executed again, the sequential training process returns to step S40. The device states of the corresponding client devices are re-confirmed one by one to re-determine the training sequence, and the trained model weight data is transmitted to the corresponding client devices as the initial model weight data for training.

In response to determining in step S46 that the sequential training process does not need to be executed again, the sequential training process proceeds to step S47: transmitting the trained model weight data back to the server device. For example, the client device 22 can store the trained model weight data D6′ and send it to the mediator module, through which the trained model weight data can then be sent back to the server device.

It should be noted that the above process can be performed in multiple mediator groups in parallel computing through multiple mediator modules, and each mediator module uses the sequential training manner to set client devices to update the weight data in a specific sequence and transmit the updated weight data to the server device. Therefore, not only biased weights can be avoided, but also communication costs can be reduced, thereby speeding up an overall training speed of the federated learning.

In addition, as shown in FIG. 4, in some embodiments, the sequential training process also includes configuring the mediator modules to perform a fault-tolerant process (step S48) for the mediator groups during the training process, such as during the steps S43 and S45 of FIG. 4.

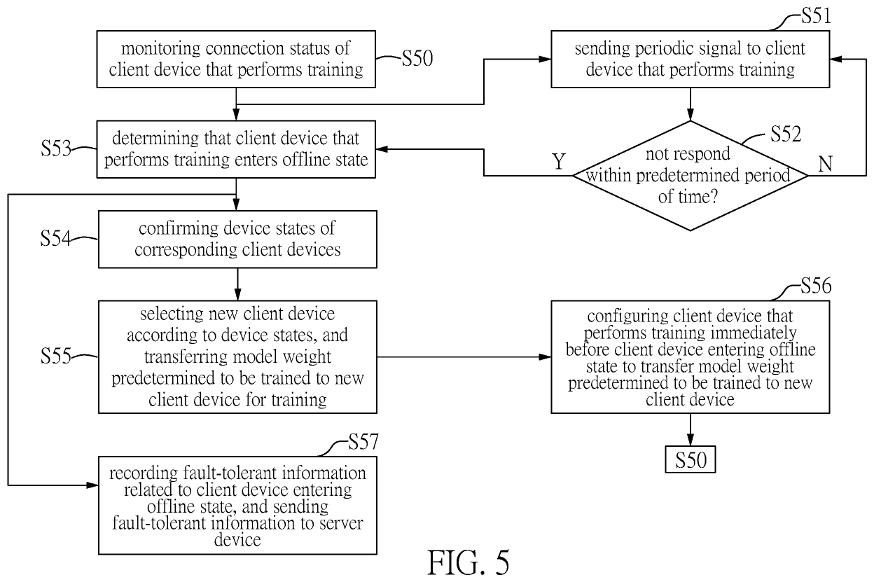

Reference is made to FIG. 5, which is a flowchart of a fault-tolerant process according to one embodiment of the present disclosure. As shown in FIG. 5, the fault-tolerant process can include the following steps:

Step S50: monitoring a connection status of the client device that performs training.

For example, the fault-tolerant process can proceed to step S51: sending a periodic signal to the client device that performs training. Step S52: determining whether or not the client device that performs training does not respond to the periodic signal within a predetermined period of time.

In response to determining that the client device that performs training does not respond to the periodic signal within the predetermined period of time, the fault-tolerant process proceeds to step S53: determining that the client device that performs training enters an offline state.

In response to detecting that the client device that performs training enters the offline state, the fault-tolerant process proceeds to step S54: confirming device states of the corresponding client devices.

Step S55: selecting a new client device from the corresponding client devices according to the device states, and transferring a model weight predetermined to be trained by the client device entering the offline state to the new client device for training.

For example, the fault-tolerant process can proceed to step S56: configuring the client device that performs training immediately before the client device that is determined to enter the offline state to transfer the model weight predetermined to be trained to the new client device.

The fault-tolerant process can then return to S50 to keep monitoring the connection status of the client device that performs training, such that the fault-tolerant process can be triggered any time when the offline state is detected.

On the other hand, every time the offline state is detected, the fault-tolerant process proceeds to step S56: recording fault-tolerant information relevant to the client device entering the offline state, and sending the fault-tolerant information to the server device. The fault-tolerant information can be, for example, the client device identifier assigned in the registration process to the client device that enters the offline state, and can assist the server device in calculating relevant weight in the subsequent steps.

Therefore, by providing a fault-tolerant mechanism under a mediator architecture of the federated learning, the training efficiency and stability of the model can be maintained even if the client device is disconnected during the training process.

Reference is further made to FIG. 3, the federated learning method proceeds to step S34: configuring all the mediator modules to return multiple records of the trained weight data to the server device. For example, the mediator modules 14-1, 14-2, . . . , 14-N shown in FIG. 1 can return trained model weights W0-1, W0-2, . . . , W0-N to the server device 12. In addition, in step S34, the mediator modules can also send the recorded fault-tolerant information back to the server device.

Step S35: configuring the server device to obtain the multiple records of the trained model weight data of the mediator groups, and calculate a plurality of weights respectively corresponding to the mediator groups according to the multiple records of the trained model weight data. For example, the server device can determine a weight of each mediator group according to amount of data generated by the training of each mediator module in the current cycle. In this step, the server device can also determine the weight of each mediator group based on the recorded fault-tolerant information.

Step S36: configuring the server device to execute a weighted federated averaging algorithm on the multiple records of the trained model weight data according to the weights to generate global model weight data.

In the present disclosure, the weighted federated averaging algorithm is also called FedAVG algorithm, which substantially includes steps of determining topology, calculating gradient, exchanging information, and aggregating models. In the architecture of the present disclosure, the step of determining the topology is to establish an initial model weight and determine the mediator modules participating in this round of federated learning. The steps of calculating the gradient and exchanging the information are to confirm the initial model weight and corresponding parameters downloaded from the server device first, and then perform local training on the client device before uploading trained model weight to the server device. It should be noted that steps S35 and S36 actually correspond to the step of aggregating model, that is, in a case that the trained model weights have been sent to the server, utilizing the server to give a weight based on the number of samples contained in the selected members (that is, all mediator modules and mediator groups), and the trained model weight of the mediator module is multiplied by the weight, summed up and averaged so that the final model weight is the one referred to as the global model weight data in step S36.

Step S37: determining, according to the global model weight data, whether or not the federated learning process needs to be executed again. For example, whether or not the federated learning process is executed again can be determined according to a training result, if it is desired to test whether or not an accuracy of the trained target model set with the global model weight data can be further improved.

In response to determining in step S37 that the federated learning process is no longer executed, the federated learning method proceeds to step S38: configuring the server device to set the target model with the global model weight data to generate a global target model.

In response to determining in step S37 that the federated learning process needs to be executed again, the federated learning method proceeds to step S39: configuring the server device to reorganize the data distribution information. For example, the client devices that have entered the offline state can be eliminated, the client devices that are newly connected to the server device can be added, and data distribution information of all the client devices can be collected again. At this time, the federated learning method can return to step S31 to perform clustering again.

It is worth mentioning that since the federated learning method and the federated learning system provided by the present disclosure add a mediation process mechanism, training tasks in the mediator group can be appropriately coordinated, thereby assisting model weights to be transferred between the client ends and server to overcome uneven distribution of data in the federated learning, while having high privacy and low cost characteristics.

In conclusion, the federated learning method and federated learning system based on the mediation process provided by the present disclosure add mediators in the federated learning to coordinate training tasks in the mediator group, thereby assisting model weights to be transferred between the client ends and server to overcome uneven distribution of data in the federated learning, while having high privacy and low cost characteristics.

In addition, the federated learning method and federated learning system based on the mediation process provided by the present disclosure provide a fault-tolerant mechanism under a mediator architecture of the federated learning, such that the training efficiency and stability of the model can be maintained even if the client device is disconnected during the training process.

Furthermore, the federated learning method and federated learning system based on the mediation process provided by the present disclosure can operate in parallel through a plurality of mediator modules, and each uses a sequential training method to allow the client devices to update the global model in a specific sequence, therefore, not only biased weights can be avoided, but also communication costs can be reduced, thereby speeding up an overall training speed of the federated learning.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A federated learning method based on a mediation process, the federated learning method comprising:
configuring a server device to divide a plurality of client devices into a plurality of mediator groups based on a plurality of records of data distribution information of the plurality of client devices, and generate a plurality of mediator modules that are configured to manage the plurality of mediator groups, respectively;
configuring the server device to broadcast initial model weight data to the plurality of mediator modules;
configuring the plurality of mediator modules to execute a sequential training process for the plurality of mediator groups, respectively, wherein the sequential training process includes:
determining a training sequence for the corresponding client devices;
transmitting the initial model weight data to the corresponding client devices, and configuring the corresponding client devices to use a plurality of records of local data as a plurality of records of training data, and sequentially train a target model according to the initial model weight data and the training sequence to generate trained model weight data; and
transmitting the trained model weight data back to the server device;
configuring the server device to obtain multiple records of the trained model weight data of the plurality of mediator groups, and calculate a plurality of weights respectively corresponding to the plurality of mediator groups according to the multiple records of the trained model weight data;
configuring the server device to execute a weighted federated averaging algorithm on the multiple records of the trained model weight data according to the plurality of weights to generate global model weight data; and
configuring the server device to set the target model with the global model weight data to generate a global target model.

2. The federated learning method according to claim 1, wherein the sequential training process further includes configuring the plurality of mediator modules to execute a fault-tolerant process for the plurality of mediator groups, respectively, wherein the fault-tolerant process includes:
monitoring a connection status of the client device that performs training;
in response to detecting that the client device that performs training enters an offline state, confirming a plurality of device states of the corresponding client devices; and
selecting a new client device from the corresponding client devices according to the plurality of device states, and transferring a model weight predetermined to be trained by the client device entering the offline state to the new client device for training.

3. The federated learning method according to claim 2, wherein the step of monitoring the connection status of the client device that performs training includes:
sending a periodic signal to the client device that performs training;
determining whether or not the client device that performs training does not respond to the periodic signal within a predetermined period of time; and
in response to determining that the client device that performs training does not respond to the periodic signal within the predetermined period of time, determining that the client device that performs training enters the offline state.

4. The federated learning method according to claim 2, wherein the step of transferring the model weight predetermined to be trained by the client device entering the offline state to the new client device for training includes:
configuring the client device that performs training immediately before the client device that is determined to enter the offline state to transfer the model weight predetermined to be trained to the new client device.

5. The federated learning method according to claim 2, wherein the fault-tolerant process further includes recording fault-tolerant information relevant to the client device entering the offline state, and sending the fault-tolerant information to the server device,
wherein, the step of configuring the server device to generate the global model weight data further includes configuring the server device to further generate the global model weight data according to multiple records of the fault-tolerant information corresponding to the plurality of mediator groups.

6. The federated learning method according to claim 1, further comprising configuring the plurality of client devices to statistically calculate the plurality of records of local data, respectively, to generate the plurality of records of data distribution information, and send the plurality of records of data distribution information to the server device.

7. The federated learning method according to claim 1, wherein the step of determining the training sequence of the corresponding client devices further includes:
confirming the plurality of device states of the corresponding client devices one by one; and
determining the training sequence according to the plurality of device states of the corresponding client devices.

8. The federated learning method according to claim 1, wherein the step of configuring the corresponding client devices to sequentially train the target model sequentially according to the initial model weight data and the training sequence to generate the trained model weight data includes:
transferring the initial model weight data to a first one of the client devices in the training sequence;
configure the first one of the client devices to train the target model with the initial model weight data, and generate first trained model weight data in response to the training being completed;
transferring the first trained model weight data to a second one of the client devices in the training sequence; and
configuring the second one of the client devices to train the target model with the first trained model weight data, and generate second trained model weight data in response to the training being completed.

9. The federated learning method according to claim 1, wherein the sequential training process further includes:
determining, according to the trained model weight data, whether or not the sequential training process needs to be executed again;
in response to determining that the sequential training process needs to be executed again, re-determining the training sequence and transmitting the trained model weight data to the corresponding client devices as the initial model weight data for training; and
in response to determining that the sequential training process does not need to be executed again, transmitting the trained model weight data back to the server device.

10. A federated learning system based on a mediation process, the federated learning system comprising:
a plurality of client devices;
a server device communicatively connected to the plurality of client devices, and configured to divide the plurality of client devices into a plurality of mediator groups based on a plurality of records of data distribution information of the plurality of client devices;
a plurality of mediator modules generated by the server device and configured to manage the plurality of mediator groups, respectively,
wherein, the server device is configured to broadcast initial model weight data to the plurality of mediator modules;
wherein, the plurality of mediator modules are configured to execute a sequential training process for the plurality of mediator groups, respectively, and the sequential training process includes:
determining a training sequence for the corresponding client devices;
transmitting the initial model weight data to the corresponding client devices, and configuring the corresponding client devices to use a plurality of records of local data as a plurality of records of training data, and sequentially train a target model according to the initial model weight data and the training sequence to generate trained model weight data; and
transmitting the trained model weight data back to the server device;
wherein, the server device is configured to obtain multiple records of the trained model weight data of the plurality of mediator groups, and calculate a plurality of weights respectively corresponding to the plurality of mediator groups according to the multiple records of the trained model weight data;
wherein, the server device is configured to execute a weighted federated averaging algorithm on the multiple records of the trained model weight data according to the plurality of weights to generate global model weight data; and
wherein, the server device is configured to set the target model with the global model weight data to generate a global target model.

11. The federated learning system according to claim 10, wherein the sequential training process further includes configuring the plurality of mediator modules to execute a fault-tolerant process for the plurality of mediator groups, respectively, and the fault-tolerant process includes:
monitoring a connection status of the client device that performs training;
in response to detecting that the client device that performs training enters an offline state, confirming a plurality of device states of the corresponding client devices; and
selecting a new client device from the corresponding client devices according to the plurality of device states, and transferring a model weight predetermined to be trained by the client device entering the offline state to the new client device for training.

12. The federated learning system according to claim 11, wherein the step of monitoring the connection status of the client device that performs training includes:
sending a periodic signal to the client device that performs training;
determining whether or not the client device that performs training does not respond to the periodic signal within a predetermined period of time; and
in response to determining that the client device that performs training does not respond to the periodic signal within the predetermined period of time, determining that the client device that performs training enters the offline state.

13. The federated learning system according to claim 11, wherein the step of transferring the model weight predetermined to be trained by the client device entering the offline state to the new client device for training includes:
configuring the client device that performs training immediately before the client device that is determined to enter the offline state to transfer the model weight predetermined to be trained to the new client device.

14. The federated learning system according to claim 11, wherein the fault-tolerant process further includes recording fault-tolerant information relevant to the client device entering the offline state, and sending the fault-tolerant information to the server device,
wherein, the step of configuring the server device to generate the global model weight data further includes configuring the server device to further generate the global model weight data according to multiple records of the fault-tolerant information corresponding to the plurality of mediator groups.

15. The federated learning system according to claim 10, wherein the plurality of client devices are further configured to statistically calculate the plurality of records of local data, respectively, to generate the plurality of records of data distribution information, and send the plurality of records of data distribution information to the server device.

16. The federated learning system according to claim 10, wherein the step of determining the training sequence of the corresponding client devices further includes:
confirming the plurality of device states of the corresponding client devices one by one; and
determining the training sequence according to the plurality of device states of the corresponding client devices.

17. The federated learning system according to claim 10, wherein the step of configuring the corresponding client devices to sequentially train the target model sequentially according to the initial model weight data and the training sequence to generate the trained model weight data includes:
transferring the initial model weight data to a first one of the client devices in the training sequence;
configure the first one of the client devices to train the target model with the initial model weight data, and generate first trained model weight data in response to the training being completed;
transferring the first trained model weight data to a second one of the client devices in the training sequence; and
configuring the second one of the client devices to train the target model with the first trained model weight data, and generate second trained model weight data in response to the training being completed.

18. The federated learning system according to claim 10, wherein the sequential training process further includes:
determining, according to the trained model weight data, whether or not the sequential training process needs to be executed again;
in response to determining that the sequential training process needs to be executed again, re-determining the training sequence and transmitting the trained model weight data to the corresponding client devices as the initial model weight data for training; and
in response to determining that the sequential training process does not need to be executed again, transmitting the trained model weight data back to the server device.
